(19) United States
(12) Patent Application Publication
(10) Pub. No.: US 2024/0301972 A1
(43) Pub. Date: Sep. 12, 2024

(54) STRAIN RELIEF WITH RETRACTOR ATTACHED TO CABLE

(71) Applicant: Rivian IP Holdings, LLC, Plymouth, MI (US)

(72) Inventors: David Day Lee, Bloomfield Hills, MI (US); David Olufemi Afolabi, Cambridge, MA (US); Jeffrey Wei Doong, Redondo Beach, CA (US); Edward James Taylor, San Diego, CA (US); Hyun Yoo, Santa Ana, CA (US); Yerin Cho, Anaheim, CA (US)

(21) Appl. No.: 18/179,463

(22) Filed: Mar. 7, 2023

(51) Int. Cl. F16L 3/12; F16L 3/14; F16L 3/20

(52) U.S. Cl. CPC F16L 3/1218; F16L 3/14; F16L 3/20

(57) ABSTRACT

The present solution provides a holder for a cable of an EV charger to maintain the cable at a position in which the cable is not bend or curved beyond a desired minimum radius of curvature, thereby preventing kinks and bends from being formed in the cable as a result of inappropriate storage, prolonging the cable longevity. The solution can include a holder for a cable of a charger for an electric vehicle. The holder can be configured to suspend from a retractor via a cord. The holder can include a handle to couple with the cord and a saddle coupled with the handle to hold the cable. A portion of the saddle can be configured to maintain a curvature of the cable at or above a minimum desired radius of curvature.

### INTRODUCTION

Electric vehicles (EVs) can have their batteries charged using chargers. Chargers can be deployed at charging sites and can provide power to various types of EVs.

### SUMMARY

The present disclosure is directed to a holder for storing a cable of a charger for charging electric vehicles at a position that provides a minimum desired bend curvature to the cable in order to avoid forming bends and kinks in the cable the during cable storage and prolong the cable longevity. Storing a charger cable in a position in which the cable is bent beyond a minimum desired curvature radius can create kinks and bends in the cable resulting in accelerated cable deterioration. The present solution addresses this issue by providing a holder in which the charger cable can be retractably suspended from a cord of a retractor and maintained at a fixed height with respect to a charging plug of an electric vehicle. The holder can include a saddle portion configured to grip and hold the charger cable at a minimum desired bend radius of curvature, thereby providing strain relief to the cable as the cable is stored between the charging events. The saddle portion of the holder can be shaped to hold the cable within the saddle and ensure that the cable is not bent beyond a radius of curvature that is at least about six times the diameter of the charger cable. By maintaining the curvature of the cable at the predetermined radius curvature (e.g., six diameters of the cable cross-section), formation of kinks or bends in the cable can be prevented and the accelerated deterioration of the cable can be avoided.

An aspect can be directed to an apparatus. The apparatus can include a holder for a cable of a charger for an electric vehicle. The holder can be configured to suspend from a retractor via a cord. The holder can include a handle to couple with the cord. The holder can include a saddle coupled with the handle to hold the cable. A portion of the saddle can be configured to maintain a curvature of the cable.

An aspect can be directed to a method. The method can include coupling, via a cord, a handle of a holder for a cable of a charger for an electric vehicle. The method can include holding, by a saddle of the holder, the cable. The method can include suspending, via the cord, the holder from a retractor. The method can include maintaining, by a portion of the saddle, a curvature of the cable suspended via the cord.

An aspect of the present disclosure can be directed to a charging system for a vehicle. The charging system can include a holder for a cable of the charger for the electric vehicle. The holder can be configured to suspend from a retractor via a cord. The holder can include a handle to couple with the cord. The holder can include a saddle coupled with the handle to hold the cable. A portion of the saddle can be configured to maintain a curvature of the cable suspended from the saddle at a radius corresponding to a predetermined threshold.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle connected to a charging station.

FIG. 2 depicts an example of an integration view of a charger cable strain relief system from a front side point of view.

FIG. 3 depicts an example of an integration view of a charger cable strain relief system from a side view point of view.

FIG. 4 depicts an example of an integration view of a charger cable strain relief system from a point of view of alongside an electric vehicle.

FIG. 5 depicts an example of a direct current (DC) cable for charging an electric vehicle held by a holder at a predetermined bend or curvature.

FIG. 6 depicts an example of an alternating current (AC) cable for charging an electric vehicle held by a holder at a predetermined bend or curvature.

FIG. 7 depicts an example of a handle having a saddle maintaining a cable at a predetermined curvature.

FIG. 8 depicts an example of a handle having a saddle with separable saddle parts maintaining a cable at a predetermined curvature.

FIG. 9 depicts an example of a cross-sectional view of a handle having an overmolded saddle maintaining a cable at a predetermined curvature.

FIG. 10 depicts an example of an EV parked at a site having chargers and retractors for charging EVs disposed from a gantry.

FIG. 11 depicts an example of holders for gantry configurations.

FIG. 12 depicts an example of holders for pedestal configurations.

FIG. 13 depicts an example of AC gantry mounted charger.

FIG. 14 depicts an example of DC pedestal chargers.

FIG. 15 depicts an example of a holder along with a handle and a saddle for holding an charger cable.

FIG. 16 depicts an example of a holder for a charger cable that can be clamped and released by a user.

FIG. 17 depicts an example of a holder having a handle connected to a ball joint for user handling.

FIG. 18 is a flow diagram illustrating an example method of providing a charge cable strain relief in accordance with elements of the systems and configurations described and illustrated herein.

### DETAILED DESCRIPTION

Following below are more detailed descriptions of various concepts related to, and implementations of, methods, apparatuses, and systems of providing strain relief to a cable of a charger. The various concepts introduced above and discussed in greater detail below may be implemented in any of numerous ways.

The present disclosure is directed to a holder for storing or maintaining a cable of an EV charger in a position in which the cable is held at a minimum desired bend radius curvature of the cable (e.g., the radius of curvature of about six times the diameter of the cable) to prevent formation of bends and kinks in the cable and prolong the cable longevity. Storing an EV charger cable in loops whose radius of curvature or bend curvature exceeds a predetermined radius threshold (e.g., bending the cable beyond a curvature threshold) can cause accelerated deterioration of the cable. As cables at a charging site can be used by various users over time, preventing storage of the cables in a manner in which the cable deterioration is accelerated can be difficult. The present disclosure provides a solution to store an EV charger cable between the cable usage so as to prevent an EV charger cable from being bent beyond a minimum desired bend radius, thereby preventing accelerated cable deterioration.

The present solution provides a holder that can be suspended from a retractable cord provided by a retractor mounted from an overhanging gantry. The overhanging gantry can support the charger along with the charger cable that can be suspended and supported by the retractable cord connected to the holder. The holder can include a saddle portion that is configured to receive the charger cable and maintain at least a minimum desired bend radius in the received cable, thereby providing strain relief to the cable as the cable rests suspended from the holder between the charging events. By maintaining the curvature of the cable at a radius of at least about six times the diameter of the charger cable, formation of kinks or bends in the cable is prevented.

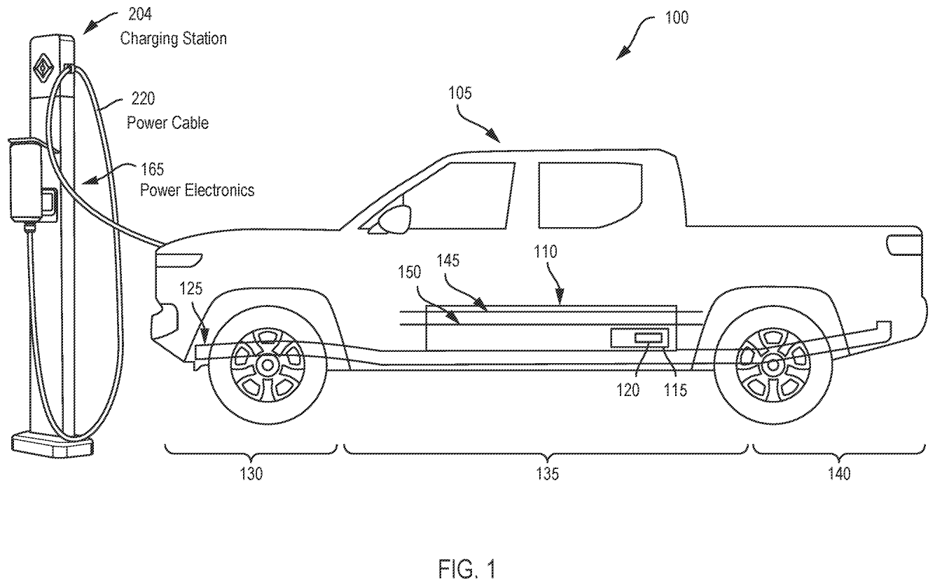

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

EV 105 can be charged by a charging station 204, which can also be referred to as a charger 204. Charger 204 can include power electronics 165 for providing power to EV 105 or drawing power from the EV 105 (e.g., providing bidirectional charging). EV 105 can be connected to the charger 204 via a power cable 220. Power cable 220, also referred to as a charger cable 220, or a cable 220, can deliver power to or from the EV 105, depending on the configuration of the charger 204. For example, in a configuration in which the charger 204 is a bidirectional charger, power cable 220 can both deliver power to the EV 105 and draw the power from the EV 105.

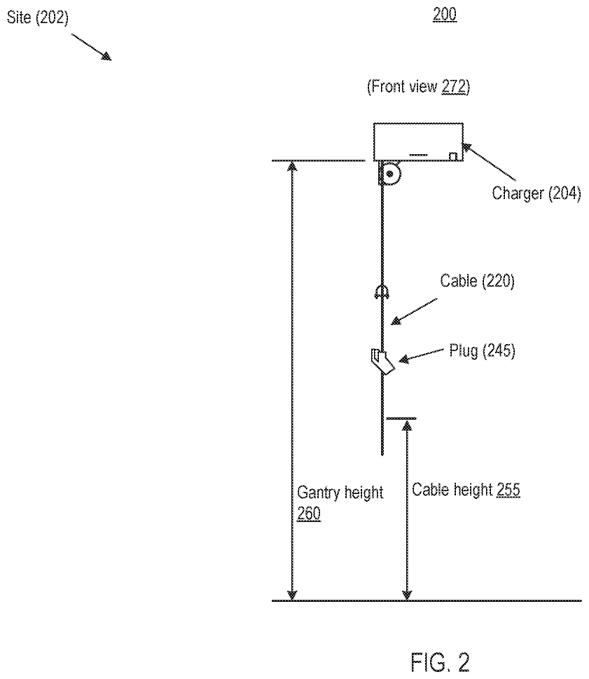

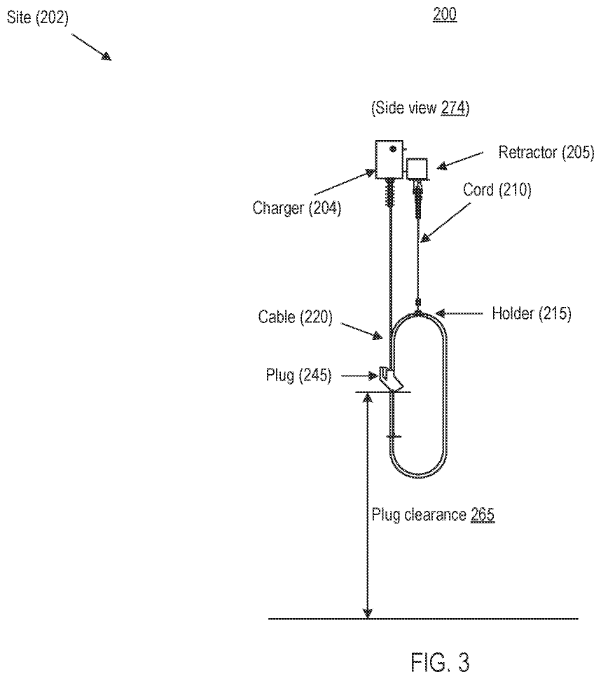

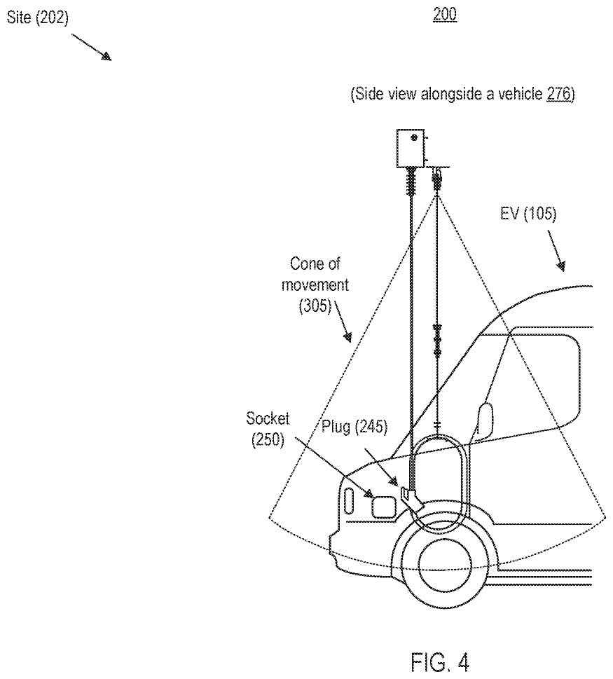

FIGS. 2-4 depict an example charger strain relief system 200 shown in a front view 272 perspective in FIG. 2, a side view 274 perspective in FIG. 3 and a side view alongside a vehicle 105 perspective in FIG. 4. The charger strain relief system of example 200 can allow for the cable 220 not to be curved or bent beyond a minimum preferred radius of curvature and thereby preventing accelerated cable deterioration. As illustrated in FIGS. 2-4, the example 200 system can include, relate to, or be deployed at, a site 202 in which one or more chargers 204 can be deployed alongside one or more retractors 205. The charger 204 can have a cable 220 that can be supported by a cord 210 suspended from a retractor 205 and attached to a holder 215. The holder 215 can grip and hold a cable 220 of a charger 204 at a minimum desired curvature radius, thereby preventing the kinks and bends from being formed in the cable 220 over time. The cable 220 can be held by its corresponding holder 215 and suspended via the cord 210.

As shown in the front view 272 of the FIG. 2, the cable 220 can have a plug 245 for charging an EV 105 that can be suspended at a cable height 255 of about two to six feet from the road (e.g., about 5 feet). The cable height 255 can be adjusted by manipulating the cord 210 through a range of height corresponding to sockets 250 of EVs 105 into which the 245 can be inserted during the charging of the EV 105. Gantry height 260 can indicate the height of the gantry 710 with respect to the road. Gantry height 260 can be at about 10 to 15 feet from the road (e.g., about 12 feet).

For example, as shown in FIG. 4, a socket 250 of the EV 105 is shown at a height that can be reached by the plug 245 given the gantry height 260 and cable height 255. Shown in the side view 274 of the FIG. 3, plug clearance 265 can be at height of about 60 to about 100 inches off the ground (e.g., 80 inches). The plug clearance 265 can correspond to a height of the socket 250 to EV 105. The cord 210 and the holder 215 can orient the loop of the cable 220 to stand parallel to a side of the EV 105 (e.g., to within plus or minus 30 degrees with respect to the EV 105) that can be parked at the site 202.

A site 202 can include any location in which chargers 204 can be disposed, deployed or located alongside their corresponding retractors 205. Site 202 can include an EV charging site having any number of chargers 204 for any number or type of EV 105 users. Site 202 can include a number of chargers 204, such as for example, two, four, eight, 10, 15, 20 or more chargers 204. A site 202 can include one or more electrical panels for integrating chargers 204 to the electrical grid. A site 202 can include a plurality of locations in which EVs 105 can be parked. Locations include chargers 204 and retractors 205. Retractors 205 can be deployed such that the cords 210 orient charger cables 220 looped through the holders 215 to stand alongside EVs 105 after the EVs 105 are parked at their designated locations. For example, a site 202 can include cables 220 suspended from chargers 204 and carried or oriented by cords 210 suspended from retractors 205, such that the cables 220 looped through holders 215 stand alongside locations in which EVs 105 are to be parked by the users prior to charging the EVs.

Charger 204, also referred to as the charging station 204, or a CS 204, can include any combination of hardware and software for providing electricity or otherwise electrically charging or discharging one or more batteries of one or more EVs 105. CS 204 can be a bidirectional charging station that can include any combination of hardware and software for providing power to or drawing power from one or more batteries of the EV 105, such as the battery packs 110, battery modules 115 or battery cells 120. Charger 204 can include scripts, functions and computer code stored in memory and executed or operating on one or more processors to implement any functionality of the charger 204. For example, charger 204 can include a computer system having one or more processors and memories, each of which can store computer code, scripts, functions and instructions to implement functionality of charger 204.

Charger 204 can include any type and form of a charger for charging an EV 105. For example, a charger 204 can include a single phase charger or a three phase charger. For example, a charger 204 can include an alternating current (AC) charger or a direct current (DC) charger. A charger 204 can be electrically coupled to one of the power lines and/or common or ground lines of an electrical panel for the site 202. For instance, one or more chargers 204 can be electrically coupled with three power lines and the ground line of an electrical panel.

The charger 204 can include electrical and power circuitry, control logic or circuits, power electronics, power supply circuitry, energy storage devices, such as batteries, and other hardware for storing, controlling, modulating or otherwise managing power, energy or electricity provided to, or drawn from, EVs 105. A charger 204 can include electric vehicle charging equipment that can include a power and control box and power cord or a cable 220. Charger 204 can include circuitry for converting alternating current (AC) to direct current (DC), such as an AC-DC converter. CS 204 can include DC-AC converters or DC-DC converters.

Charger 204 can be configured to couple with one or more EVs 105 at the same time. A charger 204 can be electrically coupled with multiple power lines and can have multiple power cables 220 to couple with multiple EVs 105. For example, a charger 204 can be connected to two power lines of an EV 105 and also be connected to a common or a ground of an electrical panel.

Charger 204 can be electrically coupled to an electrical grid via an electrical panel and can draw electricity from the grid, via the electrical panel, in order to charge EVs 105 or receive electricity from the EV batteries (e.g., 110, 115 or 120). Multiple chargers 204 can be electrically coupled with the same one or more phases of the electrical panel. Charger 204 can be set to operate, such as provide or draw electricity, at any maximum charger capacity, which can correspond to the maximum operating voltage, current or power levels, such as for example levels rated for chargers that are rated level-1, level-2 or level-3. For example, charger 204 can provide electricity to EVs 105 or draw power from EVs 105 at a maximum operating charger capacity at any voltage level, such as 220V, 208-240V or 400-900V. For example, charger 204 can operate at charger capacities corresponding to level 1, level 2 or level 3 chargers, which can cover or correspond to any power output levels between about 5 kW and 800 kW, such as for example: 5 kW, 10 kW, 20 kW, 30 kW, 50 kW, 80 kW, 100 kW, 150 kW, 120, 650 kW, 700 kW, 350 kW, 700 kW, 700 kW, 800 kW or more.

For example, a level 1 charger 204 can be configured to provide services at level 1 charger capacity which can correspond to about 110-120V, about 1.3 kW to 2.4 kW, and/or about 10 A to 20 A of current range. For example, a charger 204 can have the charger capacity set in accordance with a level 2 rated charger 204, operating at around 208V-240V, about 3 kW to 19 kW range, and about 12 A to 90 A of current range. For example, a charger 204 can have the charger capacity 250 set in accordance with level 3 rated charger 204, operating at around 400V-900V and about 50 kW to 350 kW, which can correspond to about 55 A to 875 A of current range.

Power electronics 165 can include any component, part, subsystem or system of the CS 204 used to provide charging or discharging services to EVs 105. Power electronics 165 can include circuits, components or parts providing power to EVs 105 or receiving power from EVs 105. Power electronics 165 can include one or more control boxes, including power circuitry, control electronics, controllers and circuits for managing power or communication between a CS 204 and an EV 105 via a power cable 220. Power electronics 165 can include any analog and digital circuitry, including for example, AC-DC converters, DC-DC converters, DC-AC converters, any combination of power transistors, capacitors, inductors, resistors, diodes, switches, transformers, relays and other electrical or electronic components to form structures, such as half and full bridge circuits, rectifiers, filters, multi-function circuits, single or multi-stage chargers with resonant half-bridge converts utilizing one or more inductors and one or more capacitors, such as the LLC converters and single or multi-directional DC-DC converters. Power electronics 165 can be controller or managed by processors. Power electronics 165 can include or be connected to memory, which can store scripts, computer code or instructions to be accessed or executed by electronic microcontrollers or devices, such as processors.

Charger cable 220, also referred to as a power cable 220 or a cable 220, can be attached to or coupled with power electronics 165 of a charger 204. Power cable 220 can include one or more electrical conductor wires or lines, including lines or wires for high power throughput as well as electronic or electrical signals. Power cable 220 can include or be connected to a power plug 245 for plugging into a socket 250 of an EV 105 and can include wires or lines for conducting high power, high voltage or high current between EV 105 and charger 204. Power cable 220 can include one or more wires or lines for conducting analog or digital communication signals between the EV 105 and charger 204. Power cable 220 can facilitate or provide a conduit or path for exchange of communication between EV 105 and a charger 204 and for exchange of power (e.g., electricity) between EV 105 and the charger. Charger cable 220 can be designed for high utilization, such as fleet and public charging use. Charger cable 220 can be designed to support ease of servicing. For example, charger cable 220 can include a smooth rubber material, or a soft or elastic material over its outer surface.

Retractor 205 can include any device for retractably controlling the cord 210 carrying or supporting the holder 215 holding a cable 220. Retractor 205 can include a loop (e.g., 705) for looping thereon cord 210. Retractor 205 can release a length of cord during usage of a charger 204 by a user and retract the same length of cord once the user is done using the charger 204. Retractor 205 can include a loop operating on a spring mechanism to roll a length of cord 210 in response to a release of the cord 210 by a user.

Charger 204 and retractor 205 can be deployed, suspended or otherwise provided from a gantry beam that can be located at about 10 to 15 feet above the ground, such as for example 12 to 13 feet. Cord 210 can be set up so that a user can pull the cord downward to a length beyond a threshold, such as for example a length of the plug 245 is about four to six feet off of the ground. For example, cord 210 can be set up so that the user pulls the plug 245 downward to a distance of about five feet off the ground, after which the retractor 205 can retract the cord 210 upwards and allow the user to adjust the length of the cord 210 to more conveniently insert the plug 245 into the socket 250 of the EV 105, as shown in FIG. 4.

The side view 276 of FIG. 4 also illustrates a cone of movement 305 designating a region of movement or swing of the cord 210 with the holder 215. During use of the cord 210, the holder 215 and the plug 245 can be moved by the users within the cone of movement 305, thereby allowing to allocate the space for parking the EV 105 during the charger use at a distance from the EV 105 and yet within the range of the plug 245. The cone of movement 305 for the cord 210 can also account for movement in response to wind or other elements or forces.

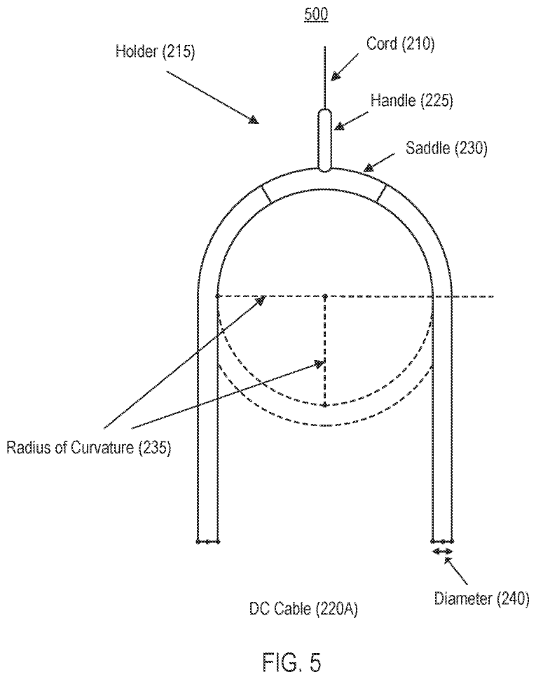

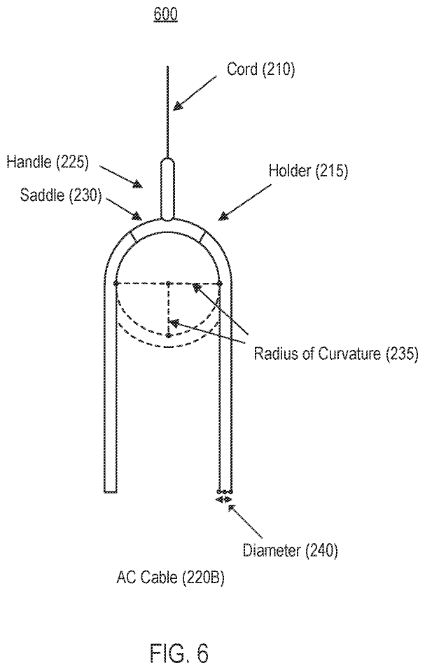

FIG. 5 illustrates an example 500 of a holder 215 for a DC cable 220A, whereas FIG. 6 illustrates an example 600 of a holder 215 for an AC cable 220B. Each of the two holders 215 in FIG. 5 and FIG. 6 can be suspended by an overhanging cord 210. Each holder 215 can grip and hold a cable 220 such that the cable 220 can be curved at a minimum desired radius of curvature. Each holder 215 can include a handle 225 connected to a cord 210 and a saddle 230 that maintains a hold or a grip on the cable 220 and keeps the cable 220 at a predetermined curvature. The predetermined curvature can correspond to a radius of curvature 235 that can be equal to or greater than about six diameters of the cable 220 that the holder 215 is holding or gripping.

FIG. 5 depicts an example 500 showing a DC cable 220A having a diameter of 38 mm. In the example 500 of FIG. 5, the saddle 230 of the holder 215 can hold the DC cable 220A at a curvature whose radius is about 228 mm, which corresponds to about 6 times the length of a diameter 240 of the DC cable 220A (e.g., 6×38 mm). By being held at a curvature of a radius of about 6 times the diameter of the DC cable 220A, the cable 220A avoids forming kinks and bends and prevents accelerated deterioration of the DC cable 220A.

FIG. 6 depicts and example 600 of an AC cable 220B of a diameter of 24 mm disposed by a holder 215. The saddle 230 of the holder 215 can hold the AC cable 220B at a curvature having a radius of about 144 mm, which can correspond to about 6 times the length of a diameter 240 of the AC cable 220B (e.g., 6×24 mm). By being held at a curvature of a radius of about 6 times the diameter of the AC cable 220B, the cable 220B can avoid forming kinks and bends and thereby improve its longevity by preventing accelerated deterioration. Therefore, both example 500 in FIG. 5 and example 600 in FIG. 6 show cables 220 of different diameters that can be held by the holders 215 at curvature whose radius is about 6 times the size of the diameter 240 of the cable 220 held in the saddle 230 of the respective holders 215.

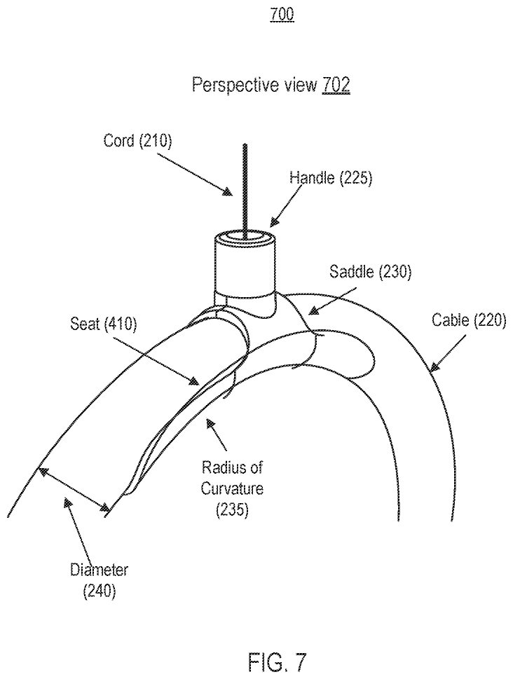

FIG. 7 depicts an example 700 having a perspective view 702 of a handle holding a cable 220 at a curvature 235, also referred to as a radius of curvature 235. The example 700 can relate to an example in which a holder 215 includes a saddle 230 that maintains or holds a cable 220 at a predetermined radius of curvature 235 that can be determined or defined based on the diameter 240 of the cable 220.

In example 700, a handle 225 can include a ball joint coupler to which the cord 210 can be coupled with the top of the handle 225. The ball joint coupler can include a cord having an end with a larger diameter than the diameter of the cord 210 and a hollow component within which the cord 210 can be inserted and screwed onto the holder 215. Handle 225 can be connected with a saddle 230 underneath the ball joint coupler. Saddle 230 can include a seat 410 within which cable 220 can be gripped. The cable 220 can run through the saddle 230 at a radius of curvature 235 that can correspond to a radius that can correspond to a multiple of diameters 240 of the cable 220. For example, the radius can correspond to five times a diameter 240, six times a diameter 240, seven times a diameter 240, eight times a diameter 240 or more than eight times a diameter 240.

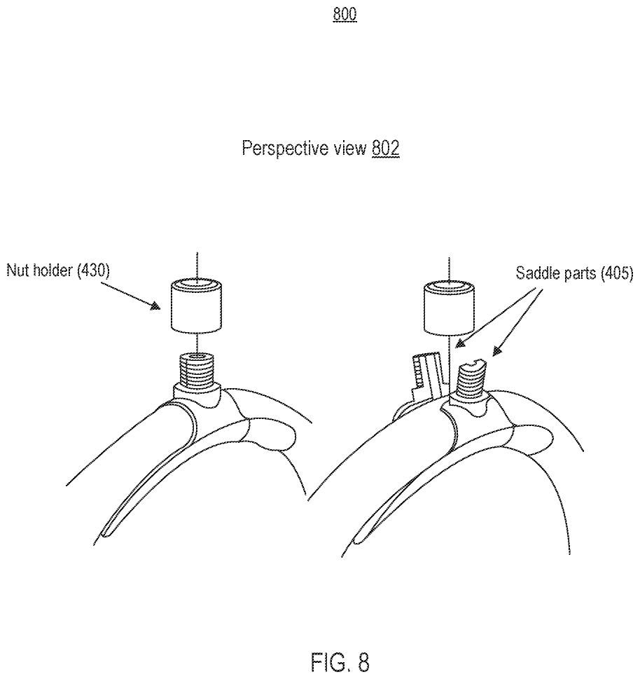

FIG. 8 illustrates an example 800 with a perspective view 802 in which a saddle 230 of the holder 215 can include two saddle parts 405. Saddle parts 405 can allow for the saddle 230 to be split or separated along a length of the saddle into a right side section and a left side section of the saddle 230. In the illustrated example 800, the saddle 230 can be connected at the lower end and have the two separated parts 405 at the top. The two saddle parts 405 can include portions of a thread (e.g., vertically split half cylinder with screw threads on their outer surface) to be screwed together by a nut holder 430 holding the two saddle parts 405 together. By screwing onto the threaded portions of the saddle parts 405, the nut holder 430 (which can also hold the ball joint coupler) can screw the handle 225 onto the two saddle parts 405 and grip the cable 220. The two parts 405 can be pulled apart in order to move the saddle 230 up or down the cable 220. The two parts 405 can be reconnected using the handle 225 to create a firm grip on the cable 220.

Holder 215, as well as any of its components (e.g., handle 225, saddle 230, saddle parts 405 or seat 410) can be produced, manufactured or formed from, or using, any kinds of materials, such as any combination of one or more of: plastic, metal, ceramic, rubber or any other material. Holder 215, as well as any of its components can be molded by one or more materials. Seat 410 can include an overmolded material 420 having flexible material (e.g., rubber, plastic or foam) so as to provide a smoother interface with cable 220 while also improving the grip on the cable 220.

Holder 215 can utilize the saddle parts 405 and nut holder 430 to provide a firm grip of the holder 215 onto the cable 220, thereby preventing slippage of the cable 220 from the holder 215. For example, the saddle parts 405 can be sized so as to firmly grip the cable 220 when a nut holder 230 is screwed onto the threads on the outer surface of the saddle parts 405. The holder 215 can be placed so as to substantially evenly (e.g., within up to 5%, 10% or 20%) balance the weight of the cable 220 on either side of the holder 215 and help maintain consistent loop orientation of the suspended charging cable 220.

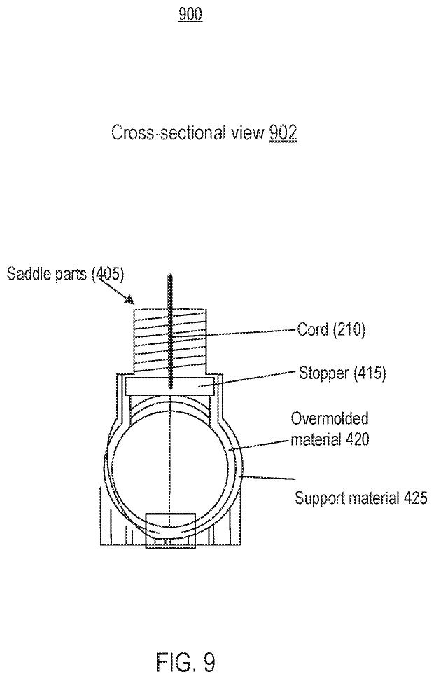

FIG. 9 illustrates an example 900 showing a cross-sectional view 902, holder 215 can include an overmolded material 420 that can be applied or overmolded over, on surface of, or in interface with, the support material 425. The support material 425 can include a material providing support to the saddle 230, such as a metal (e.g., aluminum, stainless steel, or similar) or a plastic. The retractor cord 210 can be tied to a stopper 415 that can sit above the overmolded material 420 and support material 425 and beneath two threaded saddle parts 405 that can come together to be connected by a nut holder 430 having a matching threaded interior surface holding the two threaded saddle parts 405 connected.

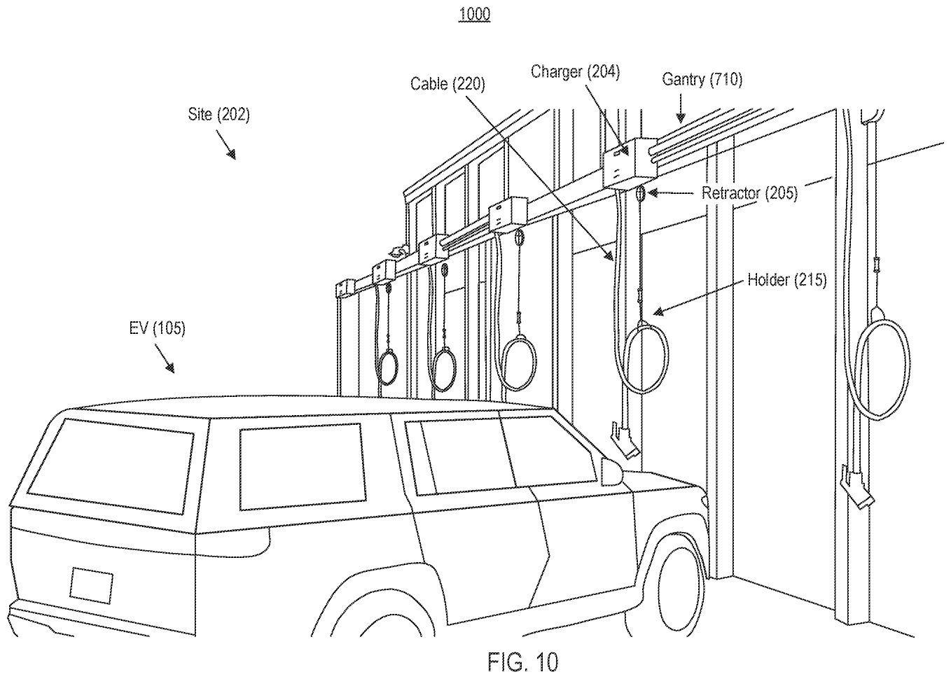

FIG. 10 depicts an example 1000 of an EV 105 parked at a site 202 that includes a plurality of chargers 204 suspended from a gantry 710, such as a gantry beam that can be located about 10-15 feet from the ground (e.g., 12 to 13 feet). The site 202 can include chargers 204 with retractors 205 mounted alongside a gantry 710. An EV 105 can be parked in a designated location that can be located alongside a cable 220 that is looped using a handle 225 that can be suspended from a cord 210 hanging from a retractor 205. Each of the chargers 204 can include a retractor 205 housed within the charger 204. Each cable 220 can be supported by a handle 225 supported by an overhanging cord 210 disposed from a retractor 205.

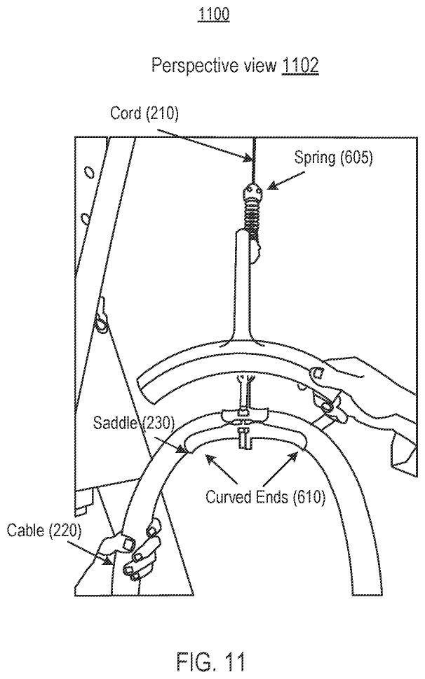

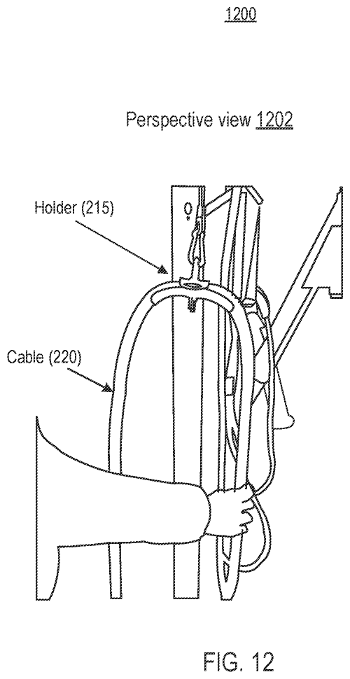

FIGS. 11 and 12 depict an example 1100 of a holder 215 in perspective view 1102 (e.g., a gantry configuration) and example 1200 of a holder in perspective view 1202 (e.g., a pedestal configuration). In perspective view 1102 of FIG. 11, the gantry configuration can include the cable 220 that can be suspended from the charger 204 that can be supported by an overhanging gantry. In the gantry configuration, chargers 204 can be located above the EVs 105. A spring 605 can be disposed between the cord 210 and the handle 225 of the holder 215. The spring 605 can act as a shock absorber, such as when a cable 220 is supported by the cord 210 or when the handle 225 is retracted by the retractor 205. Each saddle 230 can include curved ends 610. The ends 610 can be curved at the radius of curvature 235 that corresponds to the curvature at which the cable 220 is maintained (e.g., curvature having a radius that is six times the diameter of the cable). For example, the radius of the curvature 235 can increase or decrease in relation to the diameter of the cable. The relation between the radius of the curvature 235 and the diameter of the cable 220 can be such that the radius of curvature 235 is anywhere between three times and ten times the diameter of the cable, such as for example up to three times, up to four times, up to five times, up to six times, up to seven times, up to eight times, up to nine times or up to ten times of the diameter of the cable 220.

FIG. 12, in the perspective view 1202 of example 1200, shows the pedestal configuration that can have the charger 204 mounted on the ground beside the location (e.g., parking space) in which the EV 105 is to be parked prior to the charging. In the pedestal configuration, the cord 210 can be supported from a location above the charger and the holder 215 can include the saddle 230 having two curved ends 610. The user can therefore grab and handle the cable 220 from the pedestal charger 204.

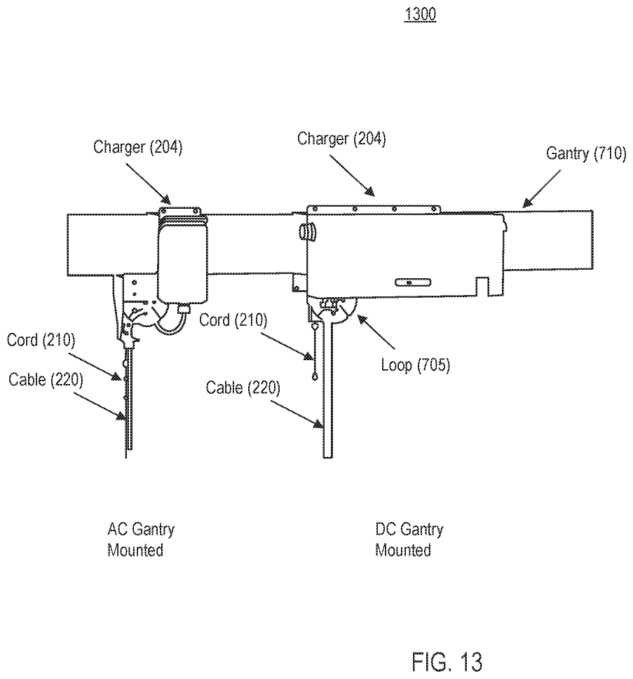

FIG. 13 depicts an example 1300 of AC charger 220B and DC charger 220B mounted on a gantry 710 that can be disposed at a height (e.g., 10-15 feet from the ground) and from which the charger strain relief system can be suspended. Example 1300 can include any number of AC chargers 204 or DC chargers 204 that can be suspended from the overhanging gantry 710 along with other parts of the system discussed herein. For example, each charger 204 can include a cord 210 carrying or supporting a cable 220. Each charger 204 can include a loop 705 of a retractor 205 for looping or rolling the cord 210 onto the loop 705. The retractor 205 for each charger 204 can be integrated into the charger 204 assembly or can be mounted off of the gantry 710 separately.

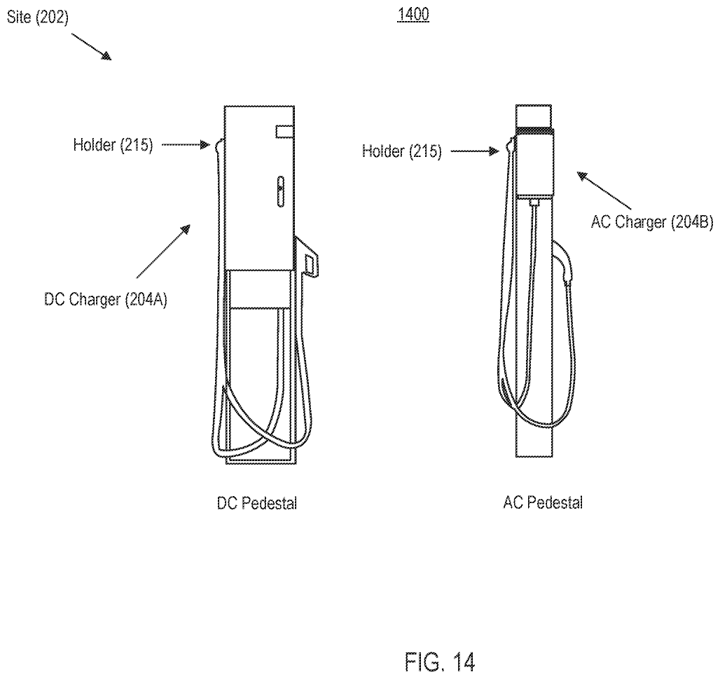

FIG. 14 illustrates an example 1400 in which a site 202 includes a DC fleet pedestal with a DC charger 204A and an AC fleet pedestal with an AC charger 204B chargers are illustrated. Shown in example 1400, both DC pedestal on the left side and the AC pedestal on the right can each have a holder 215 holding the cable 220. As chargers 204A and 204B can be mounted, disposed or otherwise provided on a ground (e.g., road or parking pavement) of the site 202, cables 220 can be suspended from the chargers 204A and 204B and held, around their mid-length, by the holders 215 (e.g., mounted at the side of the pedestals). The holders 215 can maintain the cables 220 at their desired radius of curvature 235 (e.g., radius of curvature corresponding to about 6 times the diameter 240 of the cable 220), thereby preventing bends and kinks in the cable 220 over time.

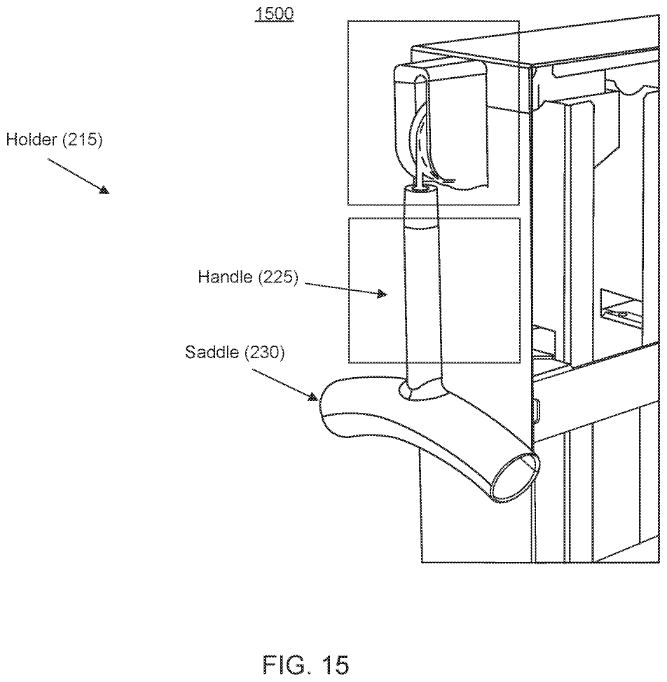

FIG. 15 depicts an example 1500 of a holder 215 along with a handle 225 and a saddle 230 for holding a charger cable 220. The holder 215 can be formed from a plastic or metal material. Each of the handle and the saddle can include, for example, components molded using plastic. Saddle 230 can be formed to grip a cable 220, while the handle 225 can be attached to a top portion of the saddle, the top end of which can be attached to a cord 210.

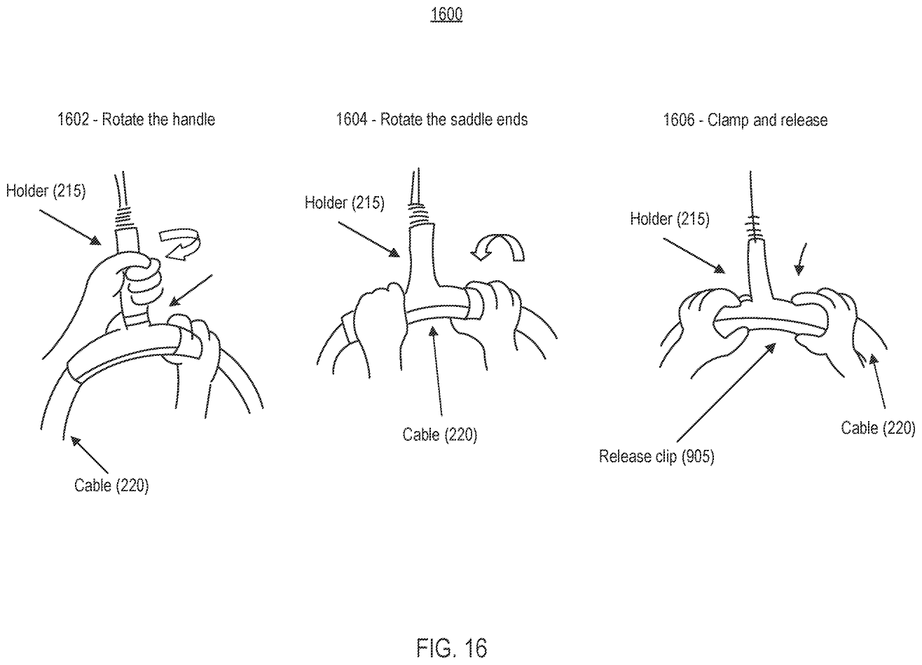

FIG. 16 depicts an example 1600 of a holder 215 for a charger cable 220 that can be clamped or clipped so as to be moved upward or downward during the course of usage and after usage released by a user to its initial position. The user could handle the charger strain relief system using movements, such as those illustrated in views 1602, 1604 and 1606 in the example 1600.

For example, at view 1602, the user can hold a handle 225 with one hand and rotate the handle of the holder 215. Rotating the handle 225 can allow the user to rotate the saddle ends, as shown in view 1604. The user can rotate the ends of the saddle 230 by twisting the ends of the saddle about the length of the cable 220 held by the saddle 230. At view 1606, the user can clamp or unclamp, or clip or unclip, or otherwise unlock the movement of the cord 210 in order to pull the holder 215 upward or downward. The holder 215 can include a release clip 905 that the user can handle (e.g., clip or clamp). For example, a user can click or press on a clamp or a release 905 to activate the release of the holder 215. In response to the release 905 being activated, the cord 210 can pull to carry the cable 220 upward. In response to the release 905 being activated, the cord 210 can be pulled downward to provide more cable 220 to the user.

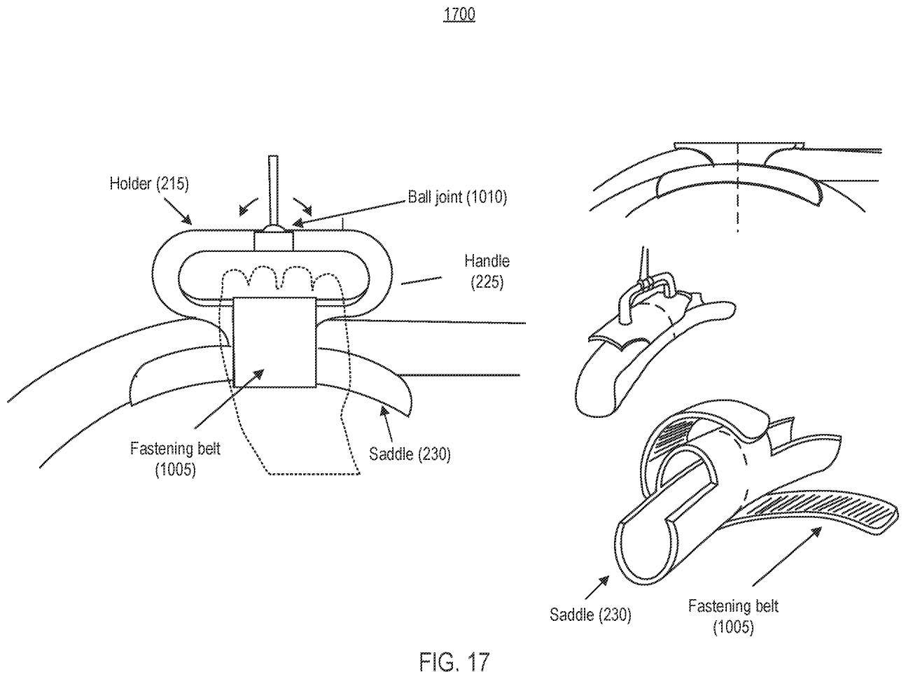

FIG. 17 depicts an example 1700 of a holder 215 having a handle 225 connected to a ball joint 1010 attaching the cord 210 to the handle 225. In example 1700, a handle 225 can include a handle loop through which the user can insert his or her fingers, or a hand, and pull the cable 220 down or push the cable 220 upward (e.g., adjust the length of the cord 210 holding the cable 220 and thereby controlling the cable 220 height during charger use). For example, a user can insert the fingers through a handle loop of the handle 225 and pull the cord 210 (and the cable 220) downward to provide more length of the cable 220. For example, a user can insert the fingers through the opening of the handle 225 and push the cord 210 upward (along with the cable 220) and shorten the length of the cable 220. Fastening belt 1005 can be provided to connect the loop handle to the saddle 230.

In some aspects, the present solution relates to a system, a device or an apparatus. The system, device or an apparatus can include a holder 215 for a cable 220 of a charger 204 for an EV 105. The holder 215 can be configured to suspend from a retractor 205. The holder 215 can be suspended from a retractor 205 via a cord 210 that can be attached to the holder 215. The holder 215 can include a handle 225 to couple with the cord 210. The handle 225 can be vertically oriented and aligned with the cord 210 from which it is suspended. The handle 225 can include a saddle 230. The saddle 230 can be coupled with the handle 225 to hold the cable 220. The handle 225 can be vertically oriented and attached to a top portion of a horizontally oriented saddle 230. The saddle 230 can include a portion of the saddle 230 that is configured to maintain a curvature (235) of the cable. For example, the saddle 230 can be shaped, configured or otherwise formed so as to grip a cable 220 disposed, held, or supported by, through or within the saddle 230.

The portion of the saddle 230 can be configured to maintain the radius of curvature 235 of the cable 220 held by or within the saddle or suspended from the saddle 230 at a radius. The radius can be equal to or correspond to a predetermined threshold. The portion the portion of the saddle 230 can be configured to maintain the radius of curvature 235 of the cable 220 suspended from the saddle 230 at a radius of at least six times a diameter 240 of the cable. For example, the radius of curvature 235 can curve the cable 220 in the saddle 230 and outside of the saddle 230 at radius of the curvature 235 that is not greater than six times a diameter 240 of the cable 220. For example, if a diameter is 25 mm, the radius of the curvature 235 can be about 150 mm or greater than 150 mm.

The retractor 205 can be configured to roll the cord 210 onto a loop 705 of the retractor 205. The retractor 205 can roll the cord 210 onto or about the loop 705 in response to a release 905 of the holder 215. For example, the retractor 205 can include a release mechanism that can include a coiled spring for the loop 705, which can be held in place by a clutch. When the clutch is released inside the retractor 205, such as when the cord 210 is pulled and then released, the cord 210 can be rolled onto the loop 705. When the cord 210 stops being rolled, the clutch can slide back in the place and hold the cord 210 in place, thereby setting the height of the cable 220 at the desired height with respect to the EV 105 or the road.

The handle 225 can be attached to the cord 210 via a spring 605. The spring 605 can be configured to absorb mechanical stress corresponding to the cord 210 pulling the holder 215 towards the retractor 205. For example, the spring 605 can absorb mechanical stress from a user pulling on the cord 210 to pull the cable 220 downward. For example, the spring 605 can absorb the mechanical stress from the handle 225 being rolled by the retractor 205 and hitting the retractor 205.

The saddle 230 can include a top portion that is separable into at least two parts 405. The two parts 405 of the saddle 230 can be configured to be pulled apart to release the cable 220 from the saddle 230. The two parts 405 can split the saddle 230 vertically and form two ends through which the cable 220 can be inserted into the saddle 230. The two parts 405 can enclose the cable 220 inserted into the saddle 230 by being brought together or pushed into each other. The at least two parts 405 can be connected by the handle 225 to fasten the cable 220 within the saddle 230. The two parts 405 can include a thread of a screw and the handle can include the corresponding thread to screw onto the two parts 405, bringing the two parts together within the handle 225.

The handle 225 can be coupled to a top portion of the saddle 230 that is coupled with the portion of the saddle 230 having two ends 610. The two ends 610 of the saddle 230 can each have a shape corresponding to the radius of curvature 235. For example, the ends 610 of the saddle 230 can be curved into a radius of curvature 235 corresponding to the radius of about six times the diameter of the cable 220 being held within the saddle 230. The shape can correspond to an arc, which can include a part of a circumference of a circle or other curve.

The cable 220 can be suspended from the charger 204 that can be suspended from a gantry 710. The retractor 205 can be suspended from the gantry 710. The retractor 205 can be disposed next to the charger 204 or can be included in the charger 204. The cord 210 from the retractor 205 can maintain a height of a plug 245 of the cable 220 at a height of a socket 250, or socket location, at the electric vehicle 105.

The cable 220 can be looped over the saddle 230. The loop of the cable 220 can be oriented along a side of the electric vehicle 105. The saddle 230 can be suspended by the cord 210 to a predetermined height over a road. For example, the cord 210 can orient the cable 220 so that the loop of the cable 220 suspended from the holder 215 (e.g., the saddle 230) is oriented alongside the side of the EV 105 that can be parked into the location of the site 202 in which the EV 105 is to be charged by the charger 204. The cord 210 can allows the cable 220 to be moved upward or downward in response to a release 905 of the handle. For example, the retractor 205 can include a release mechanism that can include a spring loaded loop held in place by a clutch, which when released pulls the cord 210 over the loop 705 of a retractor 205 to bring the cable 220 upward or downward.

In some aspects, the present solution relates to a charging system. The charging system can include a charger 204 that can include or be disposed alongside a retractor 205 for holding the cable 220 of the charger 204 in a curvature radius that prevents accelerated deterioration of the cable 220. The charging system can include a holder 215 for a cable 220 of the charger 204 for the electric vehicle 105. The holder 215 can be configured to suspend from a retractor 205 via a cord 210. The holder 215 can include a handle 225 to couple with the cord 210 and a saddle 230. The saddle 230 can be coupled with the handle 225 to hold the cable 220. A portion of the saddle 230 can be configured to maintain a curvature 235 of the cable 220 suspended from the saddle 230 at a radius corresponding to a predetermined threshold.

The portion of the saddle 230 can be configured to maintain the curvature 235 of the cable 220 suspended from the saddle 230 at a radius that can be at least six times a diameter 240 of the cable 220. For example, for a diameter 240 of a cable 220 that is about 38 mm, the saddle 230 can be shaped to hold the cable 220 at a radius of curvature that is about six times the diameter, or radius of about 228 mm. The radius of curvature can be up to about three times the diameter, up to about four times the diameter, up to about five times the diameter, up to about six times the diameter, up to about seven times the diameter, up to about eight times the diameter, up to about nine times the diameter or up to about ten times the diameter.

The cable 220 can be configured to be suspended from the charger 204 that can be suspended from a gantry 710. The retractor 205 can be configured to also be suspended from the gantry 710. The cord 210 can maintain a height of a plug 245 of the cable 220 at a height of a socket 250 location at the electric vehicle 105. For example, a release 905 can be activated at a holder 215 or at a retractor 205 to adjust the height of the holder 215 and the cable 220 so that the plug 245 of the cable 220 is at a height corresponding to a range of between about one or two feet above or one or two feet below the socket 250 of the EV 105.

In some aspects, the present solution includes a system that provides a holder 215 for a cable 220 of a charger 204 for an electric vehicle 105. The holder 215 can be configured to suspend from a retractor 205 via a cord 210. The holder 215 can include a handle 225 to couple with the cord 210. The holder can include a saddle 230 coupled with the handle 225 to hold the cable 220. A portion of the saddle 230 can be configured to maintain a curvature of the cable. The curvature can include a predetermined radius of curvature. The radius of curvature can correspond to about six lengths of the diameter of the charging cable 220.

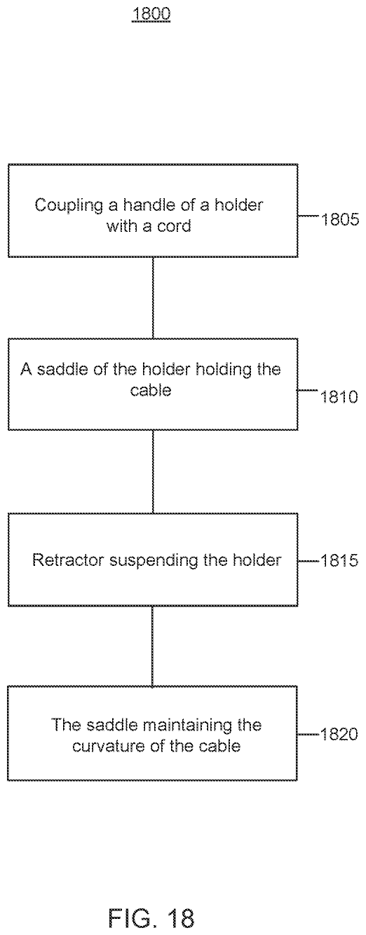

FIG. 18 illustrates a method 1800 for strain relief storage of a cable 220 of a charger 204 at a minimum predetermined radius of curvature to prevent formation of kinks or bends in the cable 220 and prevent its premature deterioration. The method 1800 can be performed using systems or features discussed in connection with FIGS. 2-17. Method 1800 can include ACTS 1805-1820. At ACT 1805, the cord can couple to a handle of a holder. At ACT 1810, a saddle of the holder can hold the cable. At ACT 1815, the retractor can suspend the holder using the cable. At ACT 1820, the saddle can maintain the cable at a predetermined curvature.

At ACT 1805, the cord can couple to a handle of a holder. The method can include a charger strain relief system coupling, via a cord, to a handle of a holder for a cable of a charger for an electric vehicle. The cord can be a cord from a retractor. The retractor can roll or loop the cord inside of the retractor to control the height of the charging cable to which the cord is attached via the holder. The cord can be rolled around a loop of a retractor operating on a loaded spring mechanism to roll the cord until a latch is applied to stop the roll. The cord can pull the handle to adjust the height of the cable held by the holder.

The method can couple the handle with a top portion of the saddle. The saddle can include two ends curved in accordance with the curvature. The saddle can grip the cable within the seat 410 of the saddle. The two ends of the saddle can include portions (e.g., at the ends of the saddle) that can be curved downward to ensure that the cable suspended from the handle is curved at a minimum desired curvature radius.

The method can suspend the cable of the charger from a gantry. The gantry can include a structure (e.g., a support beam or other support structure) from which the charger or the retractor can be suspended. The gantry can support or mount any number of chargers and retractors on a site. The method can provide the charger in a pedestal configuration. In the pedestal configuration, the retractor can be suspended from a holder at the side of the charger.

At ACT 1810, a saddle of the holder can hold the cable. The method can include the retractor attached to and holding the cord which is connected to a saddle of the holder holding the charging cable. The saddle can include a seat within which the cable can be disposed or gripped. The saddle can grip the cable located within or running through the seat of the saddle. The saddle can be curved at a predetermined curvature. The holder can include or provide a top portion of the saddle that is vertically separable into two parts to release the cable from the saddle. The top portion of the saddle can include the two parts forming a vertical cylinder with screw threads onto which a nut holder can be screwed to hold the saddle parts together and grip the cable. The two parts connected by the nut holder can fasten the cable within the saddle.

The cord, holding or suspending the holder, can suspend the plug of the cable of the charger at a height corresponding to a socket location at the electric vehicle. For example, the plug of the charger cable can be suspended at a range (e.g., plus or minus one or two feet) at which the socket of the electric vehicle is located. The saddle can loop the cable into a loop oriented along a side of the electric vehicle. For example, the loop of the cable can be oriented so that the plane of the loop is parallel to the side of the electric vehicle. The saddle can be suspended by the cord to a predetermined height over a road.

At ACT 1815, the retractor can suspend the holder via the cable. The retractor can be included inside of a charger and can be suspended from the charger or can be suspended from a gantry. The cord can suspend the holder from the retractor. The cord can be rolled into a roll or a loop inside of the retractor. The retractor can retractably roll the cord onto a loop of the retractor in response to a release mechanism of the holder. The release mechanism can include a spring loaded roller to roll the cord until a latch is applied to stop the rolling.

The cord can be connected with the holder via a spring. The spring can absorb the mechanical stress corresponding to the cord pulling the holder towards the retractor. The cord can move the cable upward or downward in response to a releasable mechanism at the handle. The holder can hold the cable at a predetermined height with respect to the road, while the cord suspended from the retractor can control the height of the holder and the cable.

At ACT 1820, the saddle can maintain the cable at a predetermined curvature. A portion of the saddle can maintain a curvature of the cable suspended via the cord. The portion of the saddle can maintain the curvature of the cable suspended from the saddle at a radius corresponding to a predetermined threshold. The portion of the saddle can maintain the curvature of the cable suspended from the saddle at a radius of at least six times the length of a diameter of the cable. The saddle can include and use the ends of the saddle to maintain the cable at the predetermined radius of curvature. The ends of the saddle can be curved at the predetermined curvature at which the charging cable can be disposed. The holder or the saddle can include can include a clip or a clamp for the user to adjust the height of the charging cable. In some instances, the predetermined curvature for the cable can correspond to the average curvature of the charging cable handled by the holder. In some instances, the predetermined curvature can correspond to the curvature of the cable at holder and the areas next to the saddle of the holder in which the cable is suspended.

For example, the saddle can maintain the curvature of the cable at a radius of curvature that is up to, or about, four times the length of the diameter of the cable. For example, the saddle can maintain the curvature of the cable at a radius of curvature that is up to, or about, five times the length of the diameter of the cable. For example, the saddle can maintain the curvature of the cable at a radius of curvature that is up to, or about, six times the length of the diameter of the cable. For example, the saddle can maintain the curvature of the cable at a radius of curvature that is up to, or about, seven times the length of the diameter of the cable. For example, the saddle can maintain the curvature of the cable at a radius of curvature that is up to, or about, eight times the length of the diameter of the cable. For example, the saddle can maintain the curvature of the cable at a radius of curvature that is up to, or about, nine times the length of the diameter of the cable. For example, the saddle can maintain the curvature of the cable at a radius of curvature that is about ten times the length of the diameter of the cable. For example, the saddle can maintain the curvature of the cable at a radius of curvature that is greater than ten times the length of the diameter of the cable.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, a positive or a negative terminal of a battery, or power direction when an electric vehicle is charged or discharged. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a holder for a cable of a charger for an electric vehicle, the holder configured to suspend from a retractor via a cord, the holder comprising:
a handle to couple with the cord; and
a saddle coupled with the handle to hold the cable, a portion of the saddle configured to maintain a curvature of the cable.

2. The apparatus of claim 1, comprising:
the portion of the saddle configured to maintain the curvature of the cable suspended from the saddle at a radius corresponding to a predetermined threshold.

3. The apparatus of claim 1, comprising:
the portion of the saddle configured to maintain the curvature of the cable suspended from the saddle at a radius of at least six times a diameter of the cable.

4. The apparatus of claim 1, wherein the retractor is configured to roll the cord onto a loop of the retractor in response to a release of the holder.

5. The apparatus of claim 1, comprising:
the handle attached to the cord via a spring configured to absorb mechanical stress corresponding to the cord pulling the holder towards the retractor.

6. The apparatus of claim 1, comprising:
the saddle comprising a top portion that is separable into at least two parts (405) to release the cable from the saddle, the at least two parts connected by the handle to fasten the cable within the saddle.

7. The apparatus of claim 1, comprising:
the handle coupled to a top portion of the saddle that is coupled with the portion of the saddle having two ends, the two ends having a shape corresponding to the curvature.

8. The apparatus of claim 1, wherein the cable is suspended from the charger that is suspended from a gantry and wherein the retractor is suspended from the gantry, the cord to maintain a height of a plug of the cable at a height of a socket location at the electric vehicle.

9. The apparatus of claim 1, wherein the cable is looped over the saddle, the loop oriented along a side of the electric vehicle and the saddle suspended by the cord to a predetermined height over a road.

10. The apparatus of claim 1, wherein the cord allows the cable to be moved upward or downward in response to a release of the handle.

11. A method, comprising:
coupling, via a cord, a handle of a holder for a cable of a charger for an electric vehicle;
holding, by a saddle of the holder, the cable;
suspending, via the cord, the holder from a retractor; and
maintaining, by a portion of the saddle, a curvature of the cable suspended via the cord.

12. The method of claim 11, comprising:
maintaining, by the portion of the saddle, the curvature of the cable suspended from the saddle at a radius corresponding to a predetermined threshold.

13. The method of claim 11, comprising:
maintaining, by the portion of the saddle, the curvature of the cable suspended from the saddle at a radius of at least six times a diameter of the cable.

14. The method of claim 11, comprising:
retractably rolling, by the retractor, the cord onto a loop of the retractor in response to a release mechanism of the holder; and
absorbing, by a spring attached to the handle, mechanical stress corresponding to the cord pulling the holder towards the retractor.

15. The method of claim 11, comprising:
providing, by the holder, a top portion of the saddle that is vertically separable into two parts to release the cable from the saddle, the two parts connected by the handle to fasten the cable within the saddle.

16. The method of claim 11, comprising:
coupling the handle with a top portion of the saddle, the saddle including two ends curved in accordance with the curvature; and
moving, via the cord, cable upward or downward in response to a releasable mechanism at the handle.

17. The method of claim 11, comprising:
suspending the cable of the charger from a gantry supporting the charger and the retractor;
suspending, by the cord, a plug of the cable at a height corresponding to a plug location at the electric vehicle; and
looping, over the saddle, the cable into a loop oriented along a side of the electric vehicle, wherein the saddle is suspended by the cord to a predetermined height over a road.

18. A charging system for a vehicle, comprising:
a holder for a cable of the charger for the electric vehicle, the holder configured to suspend from a retractor via a cord, the holder comprising:
a handle to couple with the cord; and
a saddle coupled with the handle to hold the cable, a portion of the saddle configured to maintain a curvature of the cable suspended from the saddle at a radius corresponding to a predetermined threshold.

19. The charger system of claim 18, comprising:
the portion of the saddle configured to maintain the curvature of the cable suspended from the saddle at a radius of at least six times a diameter of the cable.

20. The charger system of claim 18, comprising:
the cable configured to be suspended from the charger suspended from a gantry and the retractor is configured to be suspended from the gantry, the cord maintaining a height of a plug of the cable at a height of a socket location at the electric vehicle.
